(19) United States
(12) Patent Application Publication
(10) Pub. No.: US 2013/0289932 A1
(43) Pub. Date: Oct. 31, 2013

(54) METHOD FOR CONFIGURING A MOTION SENSOR AS WELL AS A CONFIGURABLE MOTION SENSOR AND A SYSTEM FOR CONFIGURING SUCH A MOTION SENSOR

(71) Applicant: Herbert Baechler, Zurich (CH)

(72) Inventor: Herbert Baechler, Zurich (CH)

(73) Assignee: AR INNOVATION AG, Stafa (CH)

(21) Appl. No.: 13/976,118

(22) PCT Filed: Dec. 30, 2010
(86) PCT No.: PCT/EP10/70914

§ 371 Date: Jun. 26, 2013

(51) Int. Cl. G01P 15/08

(52) U.S. Cl. CPC G01P 15/0891
USPC 702/141

(57) ABSTRACT

The present invention provides a method for configuring a motion sensor (1) comprising an accelerometer (2) and/or a gyroscope (2), a processing unit (3), a memory unit (4) and a program selection means (7). The proposed method comprises providing configuration data to the program selection means (7), selecting by the program selection means (7) a signal processing program from a plurality of signal processing programs stored in the memory unit (4) dependent on the provided configuration data, and determining by the processing unit at least one motion parameter from one or more output signals of the accelerometer (2) and/or the gyroscope (2) using the selected signal processing program. Furthermore, the present invention proposes a corresponding configurable motion sensor (1) as well as a system for configuring such a versatile motion sensor (1).

### TECHNICAL FIELD

The present invention relates to motion sensors, especially to a versatile motion sensor that can be used for a wide variety of sports, fitness, ambulatory monitoring and therapy applications. The present invention specifically pertains to a method for configuring such a versatile motion sensor, a corresponding configurable motion sensor as well as a system for configuring such a motion sensor.

### BACKGROUND OF THE INVENTION

Motion sensors have become very popular in sports for determining various performance measures. In cycling small computers on the handle bar are very common for providing information to a rider about elapsed time, distance travelled, speed and pedalling cadence. In jogging elapsed time, distance travelled, speed and pace are mostly of interest. Very different physical methods are employed to measure and determine the data of interest.

Accelerometers are applied to bicycles for various purposes, e.g. in inclinometers, speed and cadence sensors, and for determining crank and pedal position, pedalling power, etc. Meanwhile, miniature accelerometers suitable for these tasks are cheap mass products that are readily available from manufacturers such as Analog Devices, Inc. or VTI Technologies. Furthermore, miniature gyroscopes, which measure angular velocity, can also be used for motion sensing. Such devices are available for instance from Murata Manufacturing Co., Ltd.

U.S. Pat. No. 4,526,036 discloses a cadence meter comprising means for measuring acceleration intended to be mounted on a non-rotating part of a bicycle. The cadence is determined based on measuring the alternating phases of acceleration and de-acceleration of the bicycle in its direction of travel caused by the changing force applied to the pedals by the bicyclist during each pedalling cycle. A similar technique is employed in the measurement device described in EP 1 213 561 B1. This measurement device includes an accelerometer, which is mounted on a bicycle such that its measurement axis coincides with the direction of travel. The output signal of the accelerometer is processed in order to extract the frequency of pedalling, i.e. the pedalling cadence. Furthermore, WO 2008/058164 A2 presents a crank set based bicycle power measuring device wherein the pedalling cadence is required as part of the power calculation. In conjunction with determining the pedalling cadence, it is mentioned that an accelerometer mounted on a crank set can be used to measure the direction of gravity relative to the orientation of the crank. In WO 2010/000369 A1 the use of an accelerometer in a device for measurement of cycling power output is described, wherein the accelerometer is embedded in a bicycle cleat bolted to a bicyclist shoe or alternatively mounted on a pedal of a bicycle or a leg or foot of a bicyclist. It is suggested to determine the cadence based on the elapsed time between measuring consecutive minimum and maximum values, respectively, of the output signals from the accelerometer, which occur at the top dead centre and bottom dead centre, respectively, of each revolution of the cranks. Mavic, a manufacturer of bike systems and rider's equipment, employs accelerometers in its “Smart Cadence” pedalling cadence sensor which are integrated into a stretch fabric that is worn at the bicyclist's ankle. In the international application PCT/EP2010/065537 the present inventor proposes a method for determining both a bicyclist's pedalling cadence as well as a bicycle's travelling speed from the outputs of a 2/3-axis accelerometer arranged at a wheel of a bicycle.

Jogging sensors, like the stride sensors provided by Polar or Nike, employ accelerometers to determine distance and speed from the pace of steps. Such a solution is described in U.S. Pat. No. 6,018,705. The time period a foot is in contact with the ground during a stride taken by a jogger and the period that the foot is not in contact with the ground between strides taken by the jogger are determined by processing and analysing the output signals of an accelerometer.

Accelerometer-based motion sensors can also be applied in a wide variety of other sports such as rowing, skiing, cross-country skiing, golfing, exercising, swimming, ice skating, rollerblading, etc., to analyse characteristic movements and activities of an athlete. The computation of associated performance measures is often less straight forward than counting steps or detecting wheel rotations, but is well-known by those skilled in the art as evidenced by a large body of patent literature related to this topic. A few representative examples from different sports of motion sensors which employ accelerometers are given in the following. U.S. Pat. No. 7,689,378 B2 describes a motion sensing apparatus utilising a tri-axial accelerometer together with a tri-axial gyroscope as well as a tri-axial magnetometer and discloses techniques for analysing a golf stroke. US 2010/0204952 A1 describes a portable wrist worn device for determining information about the movement of a human body when swimming. WO 98/42413 A1 discloses an exercise monitoring system. WO 01/10508 A1 describes a rehabilitation device. U.S. Pat. No. 6,980,118 B2 discloses a method and apparatus for measuring stroke rating in rowing.

In the numerous applications indicated above the motion sensing device is basically always the same, namely comprising a sensor element in the form of an accelerometer and/or a gyroscope to measure motion, a processing element to process the output of the sensor element and to determine a performance measure therefrom, a communication element to send the determined data/information from the location of the sensor to a remote unit where it is displayed to a user. The difference between individual motion sensor devices essentially resides in the processing algorithms used to compute the desired performance measure and the attachment means which enable secure fixation of the motion sensor device at an appropriate measurement location, i.e. on a part of the body of an athlete or on a part of a piece of sports equipment being used by an athlete.

As a consequence of the fact that each application requires a specific attachment means for attaching the motion sensor device to the measurement location and a dedicated processing algorithm to determine a specific performance measure, an athlete, such as a triathlete, carrying out a variety of sports will require a multitude of different motion sensor devices to cover all practised sport disciplines, e.g. swimming, cycling and running.

### SUMMARY OF THE INVENTION

It is an object of the present invention to provide a versatile motion sensor which can be used for a wide variety of sports, fitness, ambulatory monitoring and therapy applications.

At least this object is achieved by a motion sensor which is configurable according to the method of claim 1. Preferred embodiments of the proposed method, a corresponding configurable motion sensor, a sensor network as well as a system for configuring such a motion sensor are given in the further claims.

A method is provided for configuring a motion sensor comprising an accelerometer and/or a gyroscope, a processing unit, a memory unit and a program selection means, the method comprising:
providing configuration data to the program selection means;
selecting by the program selection means a signal processing program from a plurality of signal processing programs stored in the memory unit dependent on the provided configuration data; and
determining by the processing unit at least one motion parameter from one or more output signals of the accelerometer and/or the gyroscope using the selected signal processing program.

In this way the motion sensor is adapted to a specific application by providing configuration data to it. The configuration data determines the way in which the one or more output signals of the accelerometer and/or the gyroscope are processed in order to obtain at least one motion parameter. To achieve this an appropriate signal processing program for processing the one or more output signals of the accelerometer and/or the gyroscope to obtain at least one desired motion parameter for a specific application is selected from a plurality of signal processing programs stored in the memory unit of the motion sensor based upon the configuration data. By doing so the signal processing applied to determine the desired motion parameter(s) is adapted to the application at hand, e.g. dependent on the arrangement of the motion sensor at the athlete or sports equipment.

Possible examples of motion parameters that are determined by the motion sensor depending on the application at hand are stride speed, acceleration, velocity, stride distance, total distance, gait/pedalling efficiency, power, energy, (maximum) impact, (average) calories consumed, maximum speed, speed variability, a cadence associated with pedalling, rowing, walking, running, cross-country skiing, roller skating, inline skating, ice skating, arm swinging or swimming stroke, punching speed and impact, springiness, striking, drive speed or throwing speed.

In an embodiment of the method, wherein the motion sensor further comprises a wireless transmitting unit, the method further comprises:
selecting a transmission protocol program from a plurality of transmission protocol programs stored in the memory unit dependent on the received configuration data; and
sending by the wireless transmitting unit the at least one motion parameter or the one or more output signals of the accelerometer and/or the gyroscope or one or more signals based on said output signals using the selected transmission protocol program.

In this way the configuration data determines the way in which the at least one motion parameter is sent to a remote device such as a sports computer, e.g. for displaying the at least one motion parameter to the user or for its further processing or storage. An appropriate transmission protocol program for sending the at least one motion parameter to the remote device is selected from a plurality of transmission protocol programs stored in the memory unit of the motion sensor based upon the configuration data. By doing so the transmission is adapted to the kind of information being determined by the motion sensor, e.g. the data format in and the data rate at which the desired motion parameter(s) is/are being produced by the motion sensor, and/or to the kind of transmission link being employed, e.g. in terms of range, speed, power, transmission channel characteristics, etc.

In a further embodiment of the method, wherein the motion sensor further comprises a receiving unit, the step of providing configuration data comprises:
receiving by the receiving unit the configuration data.

In this way the configuration data is provided to the motion sensor from a separate device via the receiving unit. By doing so the motion sensor is configured according to configuration data input to or determined at a separate, e.g. remote, device for instance as desired by user of the motion sensor.

In yet a further embodiment of the method, wherein the motion sensor further comprises a motion classification means, the method further comprises:
extracting motion features from the one or more output signals of the accelerometer and/or the gyroscope;
identifying by the motion classification means a motion pattern from a plurality of motion patterns based on the extracted motion features; and
generating at least part of the configuration data to be provided to the program selection means dependent on the identified motion pattern.

In this way the configuration data is generated by the motion sensor itself based on a motion pattern that the motion classification means has identified from a plurality of motion patterns. By doing so the motion sensor is automatically configured, i.e. it configures itself, according to the application for which it is being used by identifying the type of motion the motion sensor is sensing. Thus, the user does not need to provide this configuration data to the motion sensor. In this way the motion sensor can also automatically adapt itself to new applications based on motions patterns which are similar to know motion patterns of applications to which the motion sensor has been applied before.

Motion pattern classification is well documented for instance in “M. J. Mathie, B. G. Celler, N. H. Lovell and A. C. F. Coster, Classification of basic daily movements using a triaxial accelerometer, Med. Biol. Eng. Comput., 2004, 42, pp. 679-687” and “A. Mannini and A. M. Sabatini, Machine learning methods for classifying human physical activity from on-body accelerometers, Sensors, 2010, 10, pp. 1154-1175” as well as the publications cited therein.

In yet a further embodiment the method further comprises receiving by the receiving unit a signal processing program and/or a transmission protocol program.

In this way a further signal processing program, which is not yet stored in the memory unit of the motion sensor, is downloaded to the motion sensor. By doing so the motion sensor is able to determine one or more motion parameters for a new application that it was not able to handle before. Likewise, a further transmission protocol program, which is not yet stored in the memory unit of the motion sensor, is downloaded to the motion sensor. By doing so the motion sensor is able to support a new transmission protocol that it was not able to execute before.

In yet a further embodiment the method further comprises:
downloading a software module, which comprises at least a signal processing program and a transmission protocol program, from an application server to a sensor interfacing device or sensor hub, such as for instance a sports computer, a mobile phone or a portable digital assistant;
extracting the signal processing program and/or the transmission protocol program from the software module; and
sending the signal processing program and/or the transmission protocol program from the sensor interfacing device or sensor hub to the receiving unit.

In this way the signal processing program and/or the transmission protocol program is provided to the motion sensor from an application server via an intermediary sensor interfacing device or sensor hub, which is operationally connected to the receiving unit of the motion sensor. Different software modules for different applications can be provided by the application server. The user is able to select the desired application and the associated software module is then downloaded from the application server by the sensor interfacing device or sensor hub, which extracts the signal processing program and/or the transmission protocol program from the software module and sends either or both of them to the receiving unit of the motion sensor.

In yet a further embodiment the method further comprises receiving by the sensor hub using the transmission protocol program the at least one motion parameter or the one or more output signals of the accelerometer and/or the gyroscope or one or more signals based on said output signals from the wireless transmitting unit.

In this way the sensor hub receives data from the wireless transmitting unit by employing the same transmission protocol for receiving the data as the wireless transmitting unit is using to send the data. This is for instance achieved by extracting the transmission protocol program from the software module downloaded from the application server and distributing the transmission protocol program to both the receiving unit of the motion sensor as well as the sensor hub. By doing so it is always ensured that dependent of the kind of data and kind of transmission required by the application the appropriate transmission protocol program is being used by the wireless transmission unit of the motion sensor and the sensor hub.

In yet a further embodiment of the method, wherein the software module further comprises an application program, the method further comprises extracting the application program from the software module and executing by the sensor hub the application program for post-processing and/or displaying and/or storing the received at least one motion parameter or the one or more output signals of the accelerometer and/or the gyroscope or one or more signals based on said output signals from the wireless transmitting unit.

In this way the sensor hub is able to suitably post-process and/or display and/or store dependent on the application at hand the data sent by the wireless transmitting unit. Furthermore, by distributing the application program used by the sensor hub to perform the latter as part of the software module containing the signal processing program and the transmission protocol program it is ensured that the correct program is available at the sensor hub to receive and post-process/display/store the data sent by the wireless transmitting unit.

In yet a further embodiment the method further comprises sending by the wireless transmitting unit information regarding one or more of the following to the sensor hub:
configuration data;
identification number, such as a serial number or address data, of the motion sensor;
list of signal processing programs stored in the memory unit;
list of transmission protocol programs stored in the memory unit;
information regarding one or more of the signal processing programs or one or more of the transmission protocol programs stored in the memory unit, for instance a checksum or a version number;
information regarding the selected signal processing program or the selected transmission protocol program.

In this way the sensor hub is provided with knowledge of the configuration data which is presently being utilised by the motion sensor, so that new configuration data can be sent by the sensor hub if the application is to be altered. Furthermore, it is possible to determine the identity of the motion sensor by being provided with e.g. its serial number or some sort of address data. Knowledge of the signal processing programs and/or the transmission protocol programs stored in the memory unit is important in order to determine if an additional signal processing program and/or an additional transmission protocol program needs to be uploaded to the memory unit when for instance the motion sensor is to be applied in a new application. Moreover, information such as a checksum can be employed to determine if a certain program was uploaded correctly or corrupted due to transmission errors. Furthermore, information such as a program version number can be used to determine if a program stored in the memory unit is still up-to-date or uploading of the most recent version is necessary. Moreover, information regarding the presently selected signal processing program or the presently selected transmission protocol program can for instance be used to check if the correct program(s) was/were selected dependent on the configuration data which was provided. This information is for instance also relevant when the motion sensor has configured itself after having identified a specific motion pattern. In this way the sensor hub can adapt its transmission protocol program and/or application program to the data being provided by the wireless transmitting unit.

As a further aspect and in correspondence to the proposed method, a configurable motion sensor is provided comprising an accelerometer and/or a gyroscope, a processing unit, a memory unit, a wireless transmitting unit, a receiving unit and a program selection means, wherein the processing unit is connected to the accelerometer and/or the gyroscope, the memory unit, the wireless transmitting unit, the receiving unit and the program selection means. In such a configurable motion sensor the receiving unit is operable to receive configuration data and the processing unit is operable to determine at least one motion parameter from one or more output signals of the accelerometer and/or the gyroscope using one of a plurality of signal processing programs storable in the memory unit and selectable by the program selection means dependent on the configuration data. Moreover, the wireless transmitting unit is operable to transmit the at least one motion parameter using one of a plurality of transmission protocol programs storable in the memory unit and selectable by the program selection means dependent on the configuration data.

In a further embodiment the configurable motion sensor further comprises a separate sensor hub, such as for instance a sports computer, a mobile phone or a personal digital assistant, wherein the wireless transmitting unit is wirelessly connected to the sensor hub, and wherein the sensor hub is adapted to perform one or more of the following:
present the at least one motion parameter to the user of the sensor hub, for instance visually via a display or acoustically, e.g. via a loudspeaker;
send the at least one motion parameter to a remote computer or a data server via a communication network, e.g. by means of short message service or packet data service;
present a time series of the least one motion parameter to the user of the sensor hub via a display;
store the at least one motion parameter in a memory of the sensor hub.

In this way the data sent by the wireless transmitting unit is made available to the user in a number of different ways. For instance in numeric format to display the momentary value of a motion parameter, e.g. speed, which is continuously updated as new data is received. The received data can also be sent to a remote computer or data server for storage and later evaluation, or e.g. for monitoring by a coach/trainer, who may for instance be analysing performance data from a number of different athletes simultaneously during a training session. Furthermore, data in a certain time window, e.g. present as well as some preceding data, can be displayed at the sensor hub, or data from a previous training session can be constantly compared with the data from the present training session. In order to do the latter the received data is continuously stored in the sensor hub for later use.

In yet a further embodiment of the configurable motion sensor the sensor hub is connected to the receiving unit via a wireless connection or via a wired connection and the sensor hub is further adapted to perform one or more of the following:
send configuration data;
send a signal processing program;
send a transmission protocol program; to the receiving unit.

In this way configuration data and/or a signal processing program and/or a transmission protocol program can be provided to the receiving unit by connecting the sensor hub to the receiving unit directly by means of a cable thus providing a fast link appropriate for transferring large programs to the memory unit. Alternatively, small amounts of configuration data can be provided to the receiving unit via a wireless link from the sensor hub allowing very convenient and rapid reconfiguration of the motion sensor when the user wants to switch to a different application, e.g. a triathlete switching from cycling, where pedalling cadence was being measured by the motion sensor, to running, where the running pace is to be determined by same motion sensor perhaps being relocated from a part of the bicycle to a part of the triathlete's body.

In yet a further embodiment the configurable motion sensor further comprises motion classification means capable of identifying a plurality of motion patterns based on motion features extractable from the one or more output signals of the accelerometer and/or the gyroscope.

In yet a further embodiment of the configurable motion sensor the motion classification means is connected to the program selection means and determines the signal processing program and/or the transmission protocol program to be employed for determining the at least one motion parameter and/or for transmitting the at least one motion parameter, respectively.

In this way “self-configuration” of the motion sensor becomes possible by identifying the specific motion pattern the motion sensor is executing at the location where it is attached, e.g. to the athlete or a piece of his sports equipment.

In yet a further embodiment of the configurable motion sensor the motion classification means is located in the sensor hub and is adapted to generate at least part of the configuration data based on an identified motion pattern.

In this way the processing required for motion pattern identification takes place in the sensor hub where electrical power is available more abundantly. Furthermore, once a specific motion pattern has been identified the sensor hub is able to download an appropriate software module from the application server and then upload the necessary signal processing program and/or the associated transmission protocol program to the memory unit.

As a further aspect, a sensor network is provided comprising a plurality of configurable motion sensors and a single, common sensor hub to which all the configurable motion sensors are operationally connected.

In this way the single, common sensor hub can be employed to receive and post-process and/or display and/or store and/or forward to a remote computer or data server the data from the plurality of motion sensors. This opens up the possibility to simultaneously provide various performance measures to the user of the sensor hub or to determine more complex performance measures by the sensor hub based on data from multiple motion sensors measuring different motion parameters. Furthermore, it is possible to simultaneously determine the same performance measure for multiple users by means of a single sensor hub, e.g. for a coach of a cycling team who wants to monitor the pedalling cadence of all the riders in his team centrally from an escort vehicle during a race. Moreover, such a structure also provides redundancy which can be exploited to either derive more accurate performance values or to increase system reliability by being able to substitute faulty sensors with operational back-up sensors on the fly.

As a further aspect, a system is provided for configuring a configurable motion sensor, comprising an application server with a software database, a sensor interfacing device, such as for instance a computer, and the configurable motion sensor, wherein a plurality of software modules, e.g. for sports, fitness, ambulatory monitoring and therapy applications, requiring the motion sensor to determine at least one motion parameter are stored in the software database. Each of the plurality of software modules requiring the motion sensor comprises an application program, a signal processing program and a transmission protocol program. In such a system the sensor interfacing device is operable to download a selected software module via a communication network and to extract the signal processing program and the transmission protocol program from the selected software module and to upload the signal processing program and the transmission protocol program to the configurable motion sensor either via a wireless connection, e.g. based on the ZigBee, Bluetooth, Bluetooth Low Energy (LE), ANT+, Z-Wave, BodyLAN or Toumaz Nano Sensor Protocol (NSP) standard, or a wired connection, e.g. a USB cable.

In this way a wide variety of software modules can be provided in a simple manner for a broad range of motion sensor applications to a versatile configurable motion sensor, which can then be more universally applied than presently available sensor devices which are restricted to a single application and for determining only one motion parameter in a completely predetermined and fixed fashion.

In a further embodiment of the system the sensor interfacing device is operable to send configuration data which determine the signal processing program and/or the transmission protocol program to be used in the configurable motion sensor to the configurable motion sensor.

In this way the sensor interfacing device acts as an intermediary between the application server and the configurable motion sensor and handles the selection, retrieval and distribution of the software module as well as parts thereof.

In yet a further embodiment of the system the sensor interfacing device is further operable to extract the application program from the selected software module and to upload the application program and the transmission protocol program to a sensor hub, such as for instance a sports computer, a mobile phone or a personal digital assistant, intended in be operationally connected with the configurable motion sensor.

In this way the sensor interfacing device also acts as an intermediary between the application server and the sensor hub and further handles the extraction and transfer of parts of the software module to the sensor hub.

In yet a further embodiment of the system the sensor hub is the sensor interfacing device, i.e. performs its tasks, and is operable to execute the application program and the transmission protocol program.

In this way the sensor hub directly downloads the desired software module for a certain application from the application server, extracts the different parts and uploads them to the motion sensor with which it is associated and also executes the application program to post-process/display/store/forward the data, e.g. motion parameters, it receives from the motion sensor.

It is expressly pointed out that any combination of the above-mentioned embodiments, or combinations of combinations, is subject of a further combination. Only those combinations are excluded that would result in a contradiction.

### BRIEF DESCRIPTION OF THE DRAWINGS

For the purpose of facilitating the understanding of the present invention, exemplary embodiments thereof are illustrated in the accompanying drawings which are to be considered in connection with the following description. In this way the present invention may be more readily understood and appreciated. What is shown in the figures is the following:

FIG. 1 shows a block diagram of a configurable motion sensor according to the present invention;

FIG. 2 shows in a schematic representation a system for configuring a configurable motion sensor according to the present invention; and

FIG. 3 shows in a schematic representation a sensor network with a plurality of configurable motion sensors according to the present invention which are all operationally connected to a single, common sensor hub.

### DETAILED DESCRIPTION OF THE INVENTION

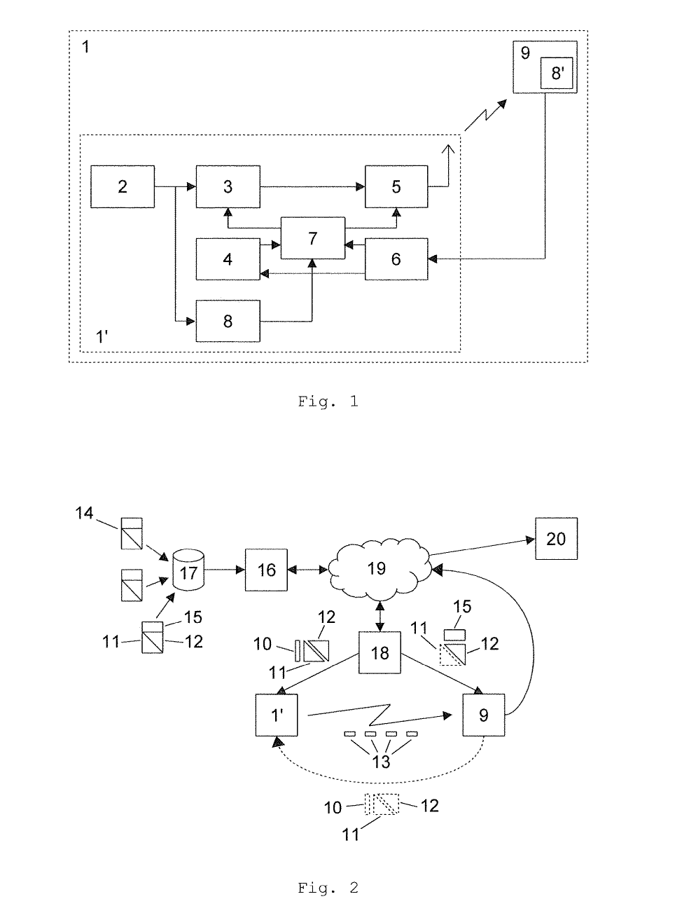

FIG. 1 depicts a block diagram of a configurable motion sensor 1. In the embodiment shown in FIG. 1 the configurable motion sensor 1 includes a sensor device 1′ and a separate sensor hub 9, which is remotely located from the sensor device 1′ during normal operation of the configurable motion sensor 1, i.e. whilst determining a desired motion parameter. The sensor device 1′ comprises an accelerometer 2 and/or a gyroscope 2 as sensor element. Suitable miniature multi-axis accelerometers for motion measurements in a plane or three-dimensional space, respectively, are the dual-axis accelerometer ADXL210 or the 3-axis accelerometer ADXL345, respectively, from Analog Devices, Inc. Suitable miniature gyroscopes for motion sensing are the GYROSTAR piezoelectric vibrating gyroscopes from Murata Manufacturing Co., Ltd.

The one or more output signals from the accelerometer 2 and/or the gyroscope 2 are provided to a processing unit 3 which determines at least one motion parameter using a signal processing program which is stored in the memory unit 4. A plurality of signal processing programs are stored in the memory unit 4 and a program selection means 7 selects the one required for determining the desired motion parameter dependent on configuration data provided to the program selection means 7 from the sensor hub 9 via a receiving unit 6.

The configuration data is transferred from the sensor hub 9 to the sensor device 1′ either wirelessly, e.g. based on the ZigBee, Bluetooth, Bluetooth Low Energy (LE), ANT+, Z-Wave, BodyLAN or Toumaz Nano Sensor Protocol (NSP) standard, or through a wired connection, e.g. a USB cable.

The one or more motion parameters determined by the processing unit 3 are subsequently sent to the sensor hub 9 via a wireless transmitting unit 5, which employs a transmission protocol program to do so. The transmission protocol program may be different depending on the type of data to be sent to the sensor hub 9. For instance several different standardised ANT+“device profiles” exist that define the network parameters and the structure of the data payload for various applications such as stride-based speed and distance monitoring, bicycle speed and cadence monitoring or monitoring a bicycle rider's expended drive power, etc. Such information forms part of the transmission protocol program. Furthermore, the transmission protocol program can also include the type of modulation and coding being employed to send the data. The transmission protocol program to be used to send the data is also determined by the configuration data that is provided to the program selection unit, which selects the required transmission protocol program from a plurality of transmission protocol programs stored in the memory unit 4. The wireless transmission scheme can for instance be based on the ZigBee, Bluetooth, Bluetooth Low Energy (LE), ANT+, Z-Wave, BodyLAN or Toumaz Nano Sensor Protocol (NSP) standard.

The sensor hub 9 can request information regarding the signal processing programs and/or the transmission protocol programs presently stored in the memory unit 4. If the sensor hub 9 detects that a program required for a certain desired application is presently not stored in the memory unit 4, it can upload a signal processing program and/or a transmission protocol program to the sensor device 1′ via the receiving unit 6. Again, as with the configuration data, this can be done wirelessly or by means of wired link such as a USB cable. The latter is more suitable for uploading programs since it allows a high transmission rate. Once all required programs are stored in the memory unit 4, wireless transmission of the configuration data from the sensor hub 9 to the sensor device 1′ is highly suitable since this allows to rapidly re-configure the sensor unit 1′ without having to physically connect the sensor unit 1′ to the sensor hub 9.

In a specific embodiment of the configurable motion sensor 1 it further comprises a motion classification means 8, 8′. This motion classification means 8, 8′ is capable of identifying a plurality of different motion patterns based on motion features which are extracted from the one or more output signals from the accelerometer 2 and/or the gyroscope 2. The motion classification means 8 can be part of the sensor device 1′ in which case the sensor device 1′ is capable of “self-configuration” dependent on the identified motion pattern. The motion classification means 8 hence generates at least part of the configuration data and provides this to the program selection means 7, which then selects the signal processing program appropriate to determine at least one motion parameter dependent on the configuration data generated by the motion classification means 8, which in turn is dependent on the motion pattern identified by the motion classification means 8. Alternatively, the motion classification means 8′ can be located in the sensor hub 9. This requires sending the output signal(s) from the accelerometer 2 and/or the gyroscope 2 or one or more signals derived therefrom to the sensor hub 9. This off-loads considerable processing from the sensor device 1′ to the sensor hub 9 so that a substantial power-savings is achievable at the sensor device 1′ where typically less power is available due to space and size limitations for incorporation of e.g. a (rechargeable) battery cell.

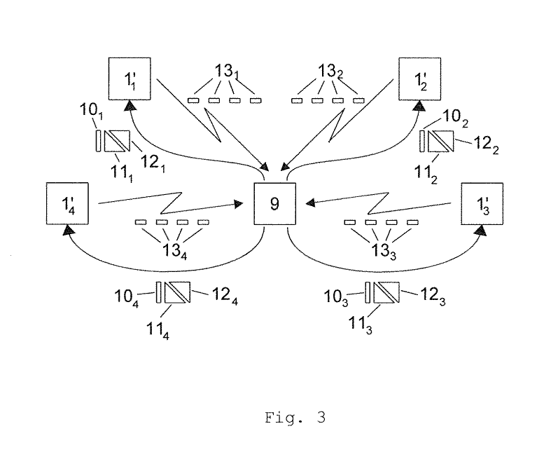

FIG. 2 depicts in a schematic representation a system for configuring the configurable motion sensor 1 illustrated in FIG. 1. A user of the configurable motion sensor 1 comprising the sensor device 1 and the associated sensor hub 9 selects a desired application provided by an application server 16 which is connected to a software database 17 containing a wide range of software modules 14 for sports, fitness, ambulatory monitoring and therapy applications. In order to select a specific application the user employs a sensor interfacing device 18 such as a computer, a portable digital assistant (PDA) or a mobile phone. Many services are available meanwhile for downloading software applications (referred to as “apps”) over the Internet to mobile devices, e.g. Apple's App Store, Nokia's Ovi Store and the Android Store. The user can select a desired application using the sensor interfacing device 18 from a plurality of applications offered by the application server 16 for instance via a web page of one of the just mentioned online stores. A software module 14 corresponding to the desired application is then downloaded from the software database 17 connected to the application server 16 via a communication network 19 such as the Internet to the sensor interfacing device 18. Each of the software modules 14 requiring the use of a configurable motion sensor 1 comprises multiple components, i.e. a signal processing program 11, a transmission protocol program 12 and an application program 15, which are intended for different parts of the configurable motion sensor 1. The sensor interfacing device 18 is capable of extracting these different components 11, 12 & 15 from the software module 14 and providing them to the parts of the configurable motion sensor 1 for which they are intended. I.e. the sensor interfacing device 18 sends the signal processing program 11 and the transmission protocol program 12 to the sensor device 1′. Moreover, the sensor interfacing device 18 can also send configuration data 10 to the sensor device 1′, so that the correct signal processing program 11 is selected for determining the desired motion parameter 13, and that the correct transmission protocol program 12 is selected for sending the determined motion parameter 13 to the sensor hub 9. Furthermore, the sensor interfacing device 18 sends the transmission protocol program 12 and the application program 15 to the sensor hub 9. The sensor hub 9 requires the transmission protocol program 12 in order to be able to receive the motion parameter 13 being sent by the sensor device 1′, and requires the application program 12 in order to be able to post-process and/or display and/or store and/or forward the received motion parameters 13. In the latter case the received motion parameters 13 is forwarded, i.e. uploaded to a remote computer or a data server 20 via the communication network 19, e.g. for centralised storage of the motion parameters or for instance for sharing them amongst a community of users such a group of cyclists or joggers.

Alternatively, instead of utilizing a sensor interfacing device 18, the tasks performed by such a device can be carried out directly by the sensor hub 9. I.e. the sensor hub 9 can download the software module 14 from the application server 16, extract the different components 11, 12 & 15 and subsequently send the signal processing program 11 and/or the transmission protocol program 12 as well as the configuration data 10 to the sensor device 1′ as indicated in FIG. 2 by the dashed arrow and the dashed blocks.

FIG. 3 depicts in a schematic representation a sensor network comprising multiple sensor devices 1_{1′}, 1_{2′}, 1_{3′}, 1_{4′} (the subscript representing the sensor device index) which are connected to a single centralised, common sensor hub 9. Different configuration data 10_{1′}, 10_{2′}, 10_{3′}, 10_{4′} can be sent to each of the plurality of sensor devices 1_{1′}, 1_{2′}, 1_{3′}, 1_{4′} from the central sensor hub 9 by using an appropriate addressing scheme as part of the transmission protocol. The signal processing programs 11_{1′}, 11_{2′}, 11_{3′}, 11_{4′} as well as the transmission protocol programs 12_{1′}, 12_{2′}, 12_{3′}, 12_{4′} can also be distributed to the different sensor devices 1_{1′}, 1_{2′}, 1_{3′}, 1_{4′} from the central sensor hub 9 by using such an addressing scheme. Each sensor device 1_{1′}, 1_{2′}, 1_{3′}, 1_{4′} then sends the data that it has determined, i.e. motion parameters 13_{1′}, 13_{2′}, 13_{3′}, 13_{4′}, to the common sensor hub 9, where it is centrally post-processed, displayed to the user of the sensor network, stored and/or uploaded to a remote computer or data server 20 via a communication network 19 (both not shown in FIG. 3; in this regard see FIG. 2).

1. A method for configuring a motion sensor (1) comprising an accelerometer (2) and/or a gyroscope (2), a processing unit (3), a memory unit (4) and a program selection means (7), the method comprising:
providing configuration data (10) to the program selection means (7);
selecting by the program selection means (7) a signal processing program (11) from a plurality of signal processing programs (11) stored in the memory unit (4) dependent on the provided configuration data (10); and
determining by the processing unit (3) at least one motion parameter (13) from one or more output signals of the accelerometer (2) and/or the gyroscope (2) using the selected signal processing program (11).

2. The method of claim 1, wherein the motion sensor (1) further comprises a wireless transmitting unit (5), the method further comprising:
selecting a transmission protocol program (12) from a plurality of transmission protocol programs (12) stored in the memory unit (4) dependent on the received configuration data (10); and
sending by the wireless transmitting unit (5) the at least one motion parameter (13) or the one or more output signals of the accelerometer (2) and/or the gyroscope (2) or one or more signals based on said output signals using the selected transmission protocol program (12).

3. The method of claim 1 or 2, wherein the motion sensor (1) further comprises a receiving unit (6), and wherein the step of providing configuration data (10) comprises:
receiving by the receiving unit (6) the configuration data (10).

4. The method of one of claims 1 to 3, wherein the motion sensor (1) further comprises a motion classification means (8), the method further comprising:
extracting motion features from the one or more output signals of the accelerometer (2) and/or the gyroscope (2);
identifying by the motion classification means (8) a motion pattern from a plurality of motion patterns based on the extracted motion features; and
generating at least part of the configuration data (10) to be provided to the program selection means (7) dependent on the identified motion pattern.

5. The method of one of the claims 1 to 4, further comprising receiving by the receiving unit (6) a signal processing program (11) and/or a transmission protocol program (12).

6. The method of claim 5, further comprising:
downloading a software module (14), which comprises at least a signal processing program (11) and a transmission protocol program (12), from an application server (16) to a sensor interfacing device (18) or sensor hub (9), such as for instance a sports computer, a mobile phone or a portable digital assistant;
extracting the signal processing program (11) and/or the transmission protocol program (12) from the software module (14); and
sending the signal processing program (11) and/or the transmission protocol program (12) from the sensor interfacing device (18) or sensor hub (9) to the receiving unit (6).

7. The method of claim 6, further comprising receiving by the sensor hub (9) using the transmission protocol program (12) the at least one motion parameter (13) or the one or more output signals of the accelerometer (2) and/or the gyroscope (2) or one or more signals based on said output signals from the wireless transmitting unit (5).

8. The method of claim 7, wherein the software module (14) further comprises an application program (15), the method further comprising extracting the application program (15) from the software module (14) and executing by the sensor hub (9) the application program (15) module for post-processing and/or displaying and/or storing the received at least one motion parameter (13) or the one or more output signals of the accelerometer (2) and/or the gyroscope (2) or one or more signals based on said output signals from the wireless transmitting unit (5).

9. The method of one of the claims 6 to 8, further comprising sending by the wireless transmitting unit (5) information regarding one or more of the following to the sensor hub (9):
configuration data (10);
identification number, such as a serial number or address data, of the motion sensor;
list of signal processing programs (11) stored in the memory unit (4);
list of transmission protocol programs (12) stored in the memory unit (4);
information regarding one or more of the signal processing programs (11) or one or more of the transmission protocol programs (12) stored in the memory unit (4), for instance a checksum or a version number;
information regarding the selected signal processing program (11) or the selected transmission protocol program (12).

10. A configurable motion sensor (1) comprising an accelerometer (2) and/or a gyroscope (2), a processing unit (3), a memory unit (4), a wireless transmitting unit (5), a receiving unit (6) and a program selection means (7), wherein the processing unit (3) is connected to the accelerometer (2) and/or the gyroscope (2), the memory unit (4), the wireless transmitting unit (5), the receiving unit (6) and the program selection means (7), and wherein the receiving unit (6) is operable to receive configuration data (10), and wherein the processing unit (3) is operable to determine at least one motion parameter (10) from one or more output signals of the accelerometer (2) and/or the gyroscope (2) using one of a plurality of signal processing programs (11) storable in the memory unit (4) and selectable by the program selection means (7) dependent on the configuration data (10), and wherein the wireless transmitting unit (5) is operable to transmit the at least one motion parameter (10) using one of a plurality of transmission protocol programs (12) storable in the memory unit (4) and selectable by the program selection means (7) dependent on the configuration data (10).

11. The configurable motion sensor (1) of claim 10, further comprising a separate sensor hub (9), such as for instance a sports computer, a mobile phone or a personal digital assistant, wherein the wireless transmitting unit (5) is wirelessly connected to the sensor hub (9), and wherein the sensor hub (9) is adapted to perform one or more of the following:
present the at least one motion parameter (13) to the user of the sensor hub (9), for instance visually via a display or acoustically, e.g. via a loudspeaker;
send the at least one motion parameter (10) to a remote computer (20) or a data server (20) via a communication network (19), e.g. by means of short message service or packet data service;
present a time series of the least one motion parameter (10) to the user of the sensor hub (9) via a display;
store the at least one motion parameter (10) in a memory of the sensor hub (9).

12. The configurable motion sensor (1) of claim 11, wherein the sensor hub (9) is connected to the receiving unit (6) via a wireless connection or via a wired connection and wherein the sensor hub (9) is further adapted to perform one or more of the following:
send configuration data (10);
send a signal processing program (11);
send a transmission protocol program (12);
to the receiving unit (6).

13. The configurable motion sensor (1) of one of the claims 10 to 12, further comprising motion classification means (8) capable of identifying a plurality of motion patterns based on motion features extractable from the one or more output signals of the accelerometer (2) and/or the gyroscope (2).

14. The configurable motion sensor (1) of claim 13, wherein the motion classification means (8) is connected to the program selection means (7) and determines the signal processing program (11) and/or the transmission protocol program (12) to be employed for determining the at least one motion parameter (10) and/or for transmitting the at least one motion parameter (10), respectively.

15. The configurable motion sensor (1) of claim 13, wherein motion classification means (8′) is located in the sensor hub (9) and is adapted to generate at least part of the configuration data (10) based on an identified motion pattern.

16. A sensor network comprising a plurality of configurable motion sensors (1, 1′) of one of the claims 10 to 15 and a single, common sensor hub (9) to which all the configurable motion sensors (1′) are operationally connected.

17. A system for configuring a configurable motion sensor (1′), comprising an application server (16) with a software database (17), a sensor interfacing device (18), such as for instance a computer, and the configurable motion sensor, wherein a plurality of software modules (14) requiring the motion sensor (1′) to determine at least one motion parameter (10) are stored in the software database (17), and wherein each of the plurality of software modules (14) requiring the motion sensor (1′) comprises an application program (15), a signal processing program (11) and a transmission protocol program (12), and wherein the sensor interfacing device (18) is operable to download a selected software module (14) via a communication network (19) and to extract the signal processing program (11) and the transmission protocol program (12) from the selected software module (14) and to upload the signal processing program (11) and the transmission protocol program (12) to the configurable motion sensor (1′).

18. The system of claim 17, wherein the sensor interfacing device (18) is operable to send configuration data (10) which determine the signal processing program (11) and/or the transmission protocol program (12) to be used in the configurable motion sensor (1′) to the configurable motion sensor (1′).

19. The system of claim 17 or 18, wherein the sensor interfacing device (18) is further operable to extract the application program (15) from the selected software module (14) and to upload the application program (15) and the transmission protocol program (12) to a sensor hub (9), such as for instance a sports computer, a mobile phone or a personal digital assistant, intended in be operationally connected with the configurable motion sensor (1′).

20. The system of one of the claims 17 to 19, wherein the sensor hub (9) is the sensor interfacing device (18), and wherein the sensor hub (9) is operable to execute the application program (15) and the transmission protocol program (12).
